(19) United States
(12) Patent Application Publication
(10) Pub. No.: US 2007/0250886 A1
(43) Pub. Date: Oct. 25, 2007

(54) Method and System for Accessing an Interactive Television Session by a Mini-Message

(75) Inventor: Jerome Chouraqui, Paris (FR)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: NPTV, PARIS (FR)

(21) Appl. No.: 10/583,049

(22) PCT Filed: Dec. 10, 2004
(86) PCT No.: PCT/FR04/50675

§ 371 Date: Apr. 3, 2007

(30) Foreign Application Priority Data
Dec. 18, 2003 (FR) 0351107

(51) Int. Cl. H04N 7/173

(52) U.S. Cl. 725/109

(57) ABSTRACT

A method of accessing an interactive television service with a code and a mini-message comprising randomly generating a code C1 by an interactive television application implemented on an interactive television set; sending a mini-message containing the code C1 to a processing server with a mobile telecommunications device; calculating a code C2=F(C1) with the processing server; resending the code C2 with the processing server and receiving the code C2 on the mobile telecommunications device; entering the C2 by the user in the interactive television application; calculating the interactive application C1′=F⁻¹ (C2); checking that C1′=C1, and enabling the user to access said service; wherein F is a predefined function, and F⁻¹ is the inverse function of F.

### RELATED APPLICATION

This is a §371 of International Application No. PCT/FR2004/050675, with an international filing date of Dec. 10, 2004 (WO 2005/062613 A1, published Jul. 7, 2005), which is based on French Patent Application No. 03/51107, filed Dec. 18, 2003.

### TECHNICAL FIELD

This disclosure relates to the field of interactive television.

### BACKGROUND

There are known solutions for accessing interactive pay television services in the previous state of the art. A classic solution consists of making the payment using a bank card. Other solutions are also known, such as payment by means of a surcharged modem connection.

### SUMMARY

This disclosure is directed to a method of accessing an interactive television service with a code and a mini-message comprising:
randomly generating a code C1 by an interactive television application implemented on an interactive television set;
sending a mini-message containing the code C1 to a processing server with a mobile telecommunications device;
calculating a code C2=F(C1) with the processing server;
resending of the code C2 with the processing server and receiving the code C2 on the mobile telecommunications device;
entering the code C2 by the user in the interactive television application;
calculating the interactive application C1′=F⁻¹(C2);
checking that C1′=C1; and
enabling the user to access the service,
wherein F is a predefined function, and F⁻¹ is the inverse function of F.

The mini-message may be in SMS format, MMS format or in the form of an e-mail.

The mini-message may be transmitted across a mobile telecommunications network or across the internet and/or a local wireless network.

Preferably, the service requires payment and the mini-message is surcharged.

A system for implementing the method is also disclosed and comprises at least a mobile telecommunications device, an interactive television set, a mobile telecommunications network or a local wireless network, a digital television broadcasting network and a processing server.

### BRIEF DESCRIPTION OF THE DRAWING

The disclosure will be understood better from reading the description, provided below for purely explanatory purposes, of selected aspects in reference to the appended FIGURE, in which:

FIG. 1 shows one selected embodiment of the method according to the invention.

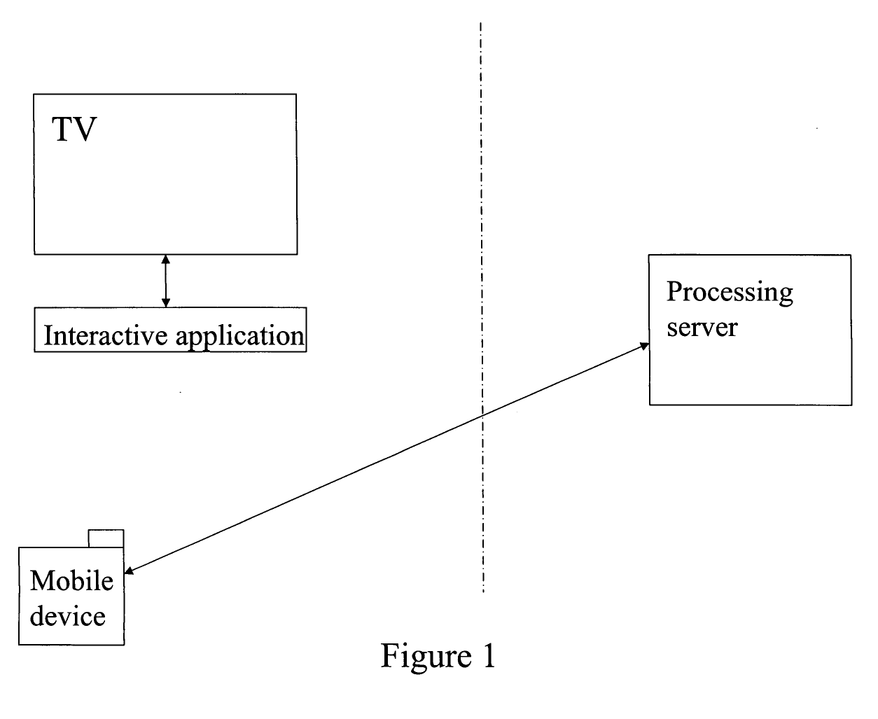

### DETAILED DESCRIPTION

In the selected example, a user has a television set connected to an interactive television decoder and a mobile telephone terminal that has capacity for sending and receiving SMS, MMS or e-mail messages. This terminal can be compatible with GSM, CDMA, GPRS, UMTS or any other digital telecommunications standard that supports sending and receiving mini-messages. It is also possible to use a PDA terminal (personal digital assistant) connected to a local wireless network (Wi-Fi or the like). It is understood that this example is non-exhaustive and that it is up to the person skilled in the art to implement variations that adapt to each specific case.

The user may watch free-access interactive television programmes. At a given instant T, he/she decides to access an interactive pay television service. The interactive television application generates a code C at random and asks the user to enter this code C on his/her mobile terminal.

In the example, the code is taken from the natural numbers under 2⁸=256 and the function used is Y=F(X)=1/x². This means that X=F⁻¹(Y)=1/√(Y).

The user then enters the code C=N₁ on his/her terminal and sends it in the form of an SMS message to a predefined number. In the example, the SMS is surcharged, in other words, the mobile telecommunications operator bills the message at a higher price than normal SMS messages and a part of this extra charge is paid back to the interactive pay television service provider.

Next, the SMS is received by a processing server, which calculates R=F(N₁)=1/(N₁)². The server sends the result R back to the user's terminal over a mobile telecommunications network.

The next step comprises the user entering R in a window of the interactive television application using his/her remote control. The interactive application calculates F⁻¹(R)=1/√(R) and checks that this value is the same, by approximation of calculations on real numbers by nearby computers, as N₁. If the verification is successful, the interactive television application authorizes the user to access the paying service.

The above method and apparatus/system is described merely as a selected example. It is understood that those skilled in the art will be able to implement different variants without therefore departing from the spirit and scope of the appended claims.

1-8. (canceled)

9. A method of accessing an interactive television service with a code and a mini-message comprising:
randomly generating a code C1 by an interactive television application implemented on an interactive television set;
sending a mini-message containing the code C1 to a processing server with a mobile telecommunications device;
calculating a code C2=F(C1) with the processing server;
resending the code C2 with the processing server and receiving the code C2 on the mobile telecommunications device;
entering the C2 code by the user in the interactive television application;
calculating the interactive application C1′=F⁻¹(C2);
checking that C1′=C1; and
enabling the user to access the service,
wherein F is a predefined function, and F⁻¹ is the inverse function of F.

10. The method according to claim 9, wherein the mini-message is in SMS format.

11. The method according to claim 9, wherein the mini-message is in MMS format.

12. The method according to claim 9, wherein the mini-message is in the form of an e-mail.

13. The method according to claim 9, wherein the mini-message is transmitted across a mobile telecommunications network.

14. The method according to claim 9, wherein the mini-message is transmitted across the internet and/or a local wireless network.

15. The method according to claim 9, wherein the service requires payment and the mini-message is surcharged.

16. The method according to claim 10, wherein the service requires payment and the mini-message is surcharged.

17. The method according to claim 11, wherein the service requires payment and the mini-message is surcharged.

18. A system for accessing an interactive television service comprising at least a mobile telecommunications device, an interactive television, a mobile telecommunications network or a local wireless network, a digital television broadcasting network and a processing server.

19. A system for accessing an interactive television service comprising at least a mobile telecommunications device, an interactive television, a mobile telecommunications network or a local wireless network, a digital television broadcasting network and a processing server, wherein the system randomly generates a code C1 by an interactive television application implemented on an interactive television set;
sends a mini-message containing the code C1 to a processing server with a mobile telecommunications device;
calculates a code C2=F(C1) with the processing server;
resends the code C2 with the processing server and receiving the code C2 on the mobile telecommunications device;
enters the C2 code by the user in the interactive television application;
calculates the interactive application C1′=F⁻¹(C2);
checks that C1′=C1; and
enables the user to access the service,
wherein F is a predefined function, and F⁻¹ is the inverse function of F.
